(19) United States
(12) Patent Application Publication
(10) Pub. No.: US 2014/0292998 A1
(43) Pub. Date: Oct. 2, 2014

(54) Managing Use of Resources in Mobile Devices

(71) Applicant: James Toga, Wayland, MA (US)

(72) Inventor: James Toga, Wayland, MA (US)

(21) Appl. No.: 13/855,230

(22) Filed: Apr. 2, 2013

(51) Int. Cl. G06F 9/50; H04N 7/14

(52) U.S. Cl. CPC G06F 9/50; H04N 7/141
USPC 348/14.02; 718/104

(57) ABSTRACT

Methods and apparatus, including computer program products, for managing use of resources in mobile devices. A method includes, in a mobile device comprising at least a display, a processor and a memory, reading data of a sensor of the device, determining from the sensor data that the device is in an operating circumstance for processing the data in a fashion that consumes a different amount of a resource, and processing the data in a fashion that consumes a different amount of the resource.

### BACKGROUND OF THE INVENTION

The present invention generally relates to resource management, and particularly to managing use of resources in mobile devices.

In recent years, mobile devices have become increasingly capable. For example, smartphones are used not just for telephone communications, but are increasingly used for applications that include navigation, playing games, accessing the Internet, scheduling, entertainment, transmitting receiving or watching videos, and so forth. There are a number of applications on mobile devices for VOIP (Voice-Over-IP) audio communications over wireless connections to the Internet, and for real-time “video-call” communications over networks such as the Internet, including bi-directional calls. Examples of mobile devices are smartphones, audio and video players and recorders, laptops, netbooks, portable computation devices, electronic pocket organizers, and so forth.

Mobile devices, while increasingly powerful, by their nature have limited resources. Examples include electrical power—power may be available for periods of time only from an internal battery; computation—the processor or computer is only able to perform a finite amount of computation in a given amount of time (and further the mount of resource available may vary due to other factors, such the clock rate being raised or lowered as a matter of simple power management); and bandwidth—the device may be only able to transmit or receive data at up to a limited maximum speed, which may also vary. Further, the amount of a given resource that is available may at times be different than at other times, or may be consumed at a different rate, depending on other functions of the device or environmental factors.

Medial processing, such as video processing, is often particularly costly in consuming electrical power, computational resources, and communications bandwidth.

Generally, video at higher detail consumes computation and communication resources at a higher rate than at less detail.

Similarly, encoding or decoding video information when the video image is changing (e.g. because either the subject or the video camera are moving) generally consumes computation at a higher rate than when the video images are changing less, dependent on the particular form of video data and how it may be encoded.

Thus, there is a continuing need for techniques for managing resource consumption in mobile devices more optimally.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

One aspect of the present invention is a method of that it is appropriate to process data in a fashion that consumes a different amount of a resource in a mobile device by reading data of a sensor of the device, determining from the sensor data that the device is in an operating circumstance for processing the data in a fashion that consumes a different amount of a resource, and processing the data in a fashion that consumes a different amount of a resource.

In another aspect, the data may be multimedia data such as video data. In further aspects, the circumstance may be that the device is in motion, the circumstance may be that the device is in an orientation, or the circumstance may be that that there is insufficient ambient light for a camera of the device to produce usable images. The sensor may be any of a number of kinds of sensors.

In further aspects, quantity, form, or type of data processed or encoded in an originating device may be determined based on a sensor reading, and the amount of a resource consumed by a receiving or a rendering device of the data optimized. In aspects of some embodiments, images may be blurred or encoded at a different level of image detail when the circumstance is determined that an originating device is in motion. In other aspects, the circumstance may be an orientation where the device is an accepting device of the data and will produce video information of different value, such as when the device is held next to the user's head, or is face-down on a flat surface The orientation may be an orientation where the device is a displaying device of the data and video information will not be seen by readily a user, such as when the device is held against the user's ear, or the device is positioned inside a pocket of the user.

The circumstance may also be for a device that is an accepting device in which the information is video information, that the video sensor (camera) is blocked by an object detected by means of a touch or proximity sensor. The circumstance may also be for a device that is a rendering device in which the information is video information, that the video display is blocked by an object or the device is in motion.

The processing may include computational or communications processing of media data such as video, and the resource may be a limited resource such as battery power, bandwidth, or computation, for processing and/or communicating real-time audio and/or video information. Further aspects of the invention are directed to using other kinds of sensor data, such as touch data, and other kinds of processing.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

The invention will be more fully understood by reference to the detailed description, in conjunction with the following figures, wherein:

FIG. 1 illustrates an exemplary mobile device.

FIG. 2 shows an oblique view of an exemplary mobile device.

FIG. 3 is a flow diagram.

FIG. 4 is a flow diagram.

FIG. 5 is a flow diagram.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component,” “system,” “platform,” and the like can refer to a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

In addition, the term “or” is intended to mean an inclusive “or” rather than an exclusive “or.” That is, unless specified otherwise, or clear from context, “X employs A or B” is intended to mean any of the natural inclusive permutations. That is, if X employs A, X employs B, or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

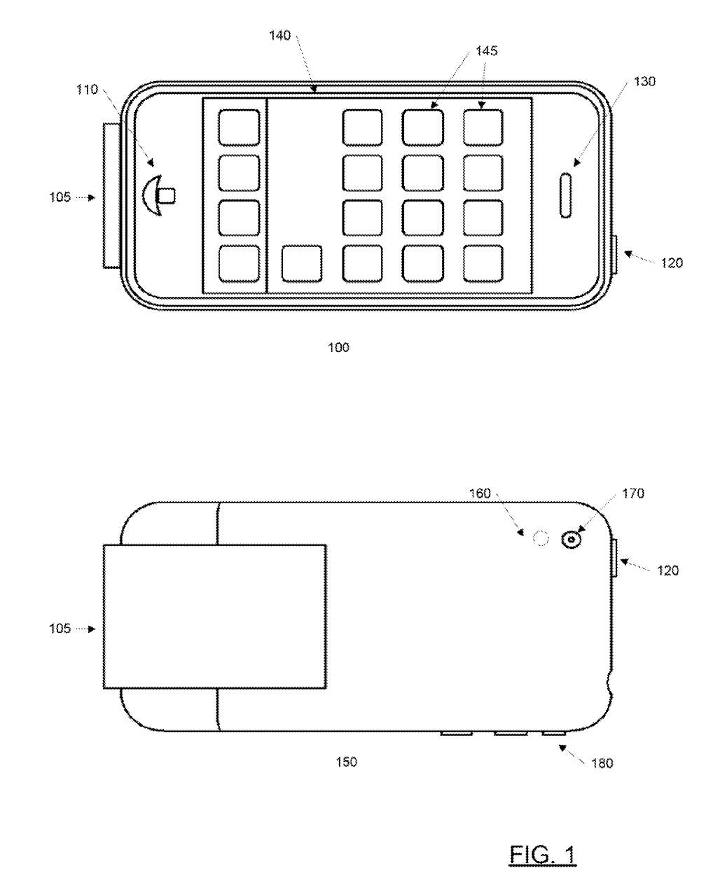

FIG. 1 illustrates an exemplary mobile device, such as a smart phone. Smart phones in this context include devices using operating software of the iPhone®, the Android® operating system (also referred to as Droid®), the Symbian® operating system, software based on Linux® and others. Mobile devices in the present context need not have phone capabilities, nor need they include video camera capabilities. Further representative examples of mobile devices include without limitation digital cameras, video recording devices, mobile computing devices with a keyboard, touchscreen, image recognizer, voice input, or other user input means, audio and video players, and so forth.

100 in FIG. 1 shows a front view of the exemplary mobile device: 150 shows a rear view. As illustrated, 140 is a touch screen for touch input and display, showing representative icons or tiles such as 145. 130 is an audio output transducer that may be used by appropriate applications for audio chats when the device is held against a user's ear in “telephone use”. 110 is the location of a microphone transducer for audio chats. Also visible is connector 105 for external connector or docking. Power button 120 may be used to turn the device on or off, or optionally put it into a “sleep” mode.

The device may include one or more sensors such as a vibration sensors, an accelerometer, one or more magnetic sensors, a gyroscopic sensor, additional audio sensors or transducers, and so forth.

150 shows a rear view of the exemplary device: visible are connector 105 and power button 120. Also visible are exemplary volume and camera-control buttons 180. Video camera 170 is seen adjacent to ambient light sensor 160. In some embodiments, ambient light may be detected by video camera 170.

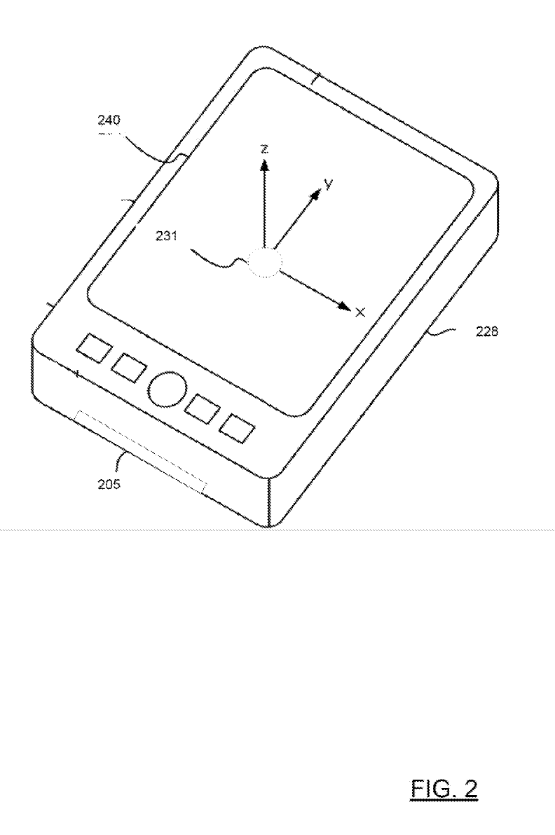

FIG. 2 shows an oblique view of an exemplary mobile device. Shown are connector 205, and touch screen 240. 228 indicates the rear surface like that shown in 150 of FIG. 1. 231 illustrates the three axes relative to touchscreen 240, for the data of an internal accelerometer.

One representative form of a preferred embodiment is a method performed by a processor of a mobile device. The mobile device may be running a version of the Android® operating software, which is readily understood in the present context. There are further kinds of mobile devices such as iPhones®, iPods®, Symbian® smartphones, Web tablets, and Android® tablets. For example, devices running a version of the Android® operating software may support multiple kinds of sensors that sense orientation or change of orientation in the devices.

These sensors of mobile devices can include accelerometers, gyroscopic sensors, magnetic field sensors, and so forth. The sensors may provide data for up to three axes or more, and may report data in forms such as directional vectors, rotation vectors, or change in orientation, inclination, or positions. Information from multiple sensors can be combined, such as combining higher frequency data from a gyroscopic sensor with lower frequency data from an accelerometer sensor for a more optimal determination of orientation. Orientation and motion can e determined using various and other kinds of sensors, such as touch sensors to determine that a smart phone is being held in contact with a user's head, or proximity sensors (for example, electrostatic or acoustic proximity sensors) to determine that an object is obscuring a display due to the devices orientation with respect to the object.

Orientation or motion of course may be determined with respect to various references, such as the direction of gravity, a presumed surface such as a table surface, or a proximate object for example a side of a user's head or the inside of a pocket or container.

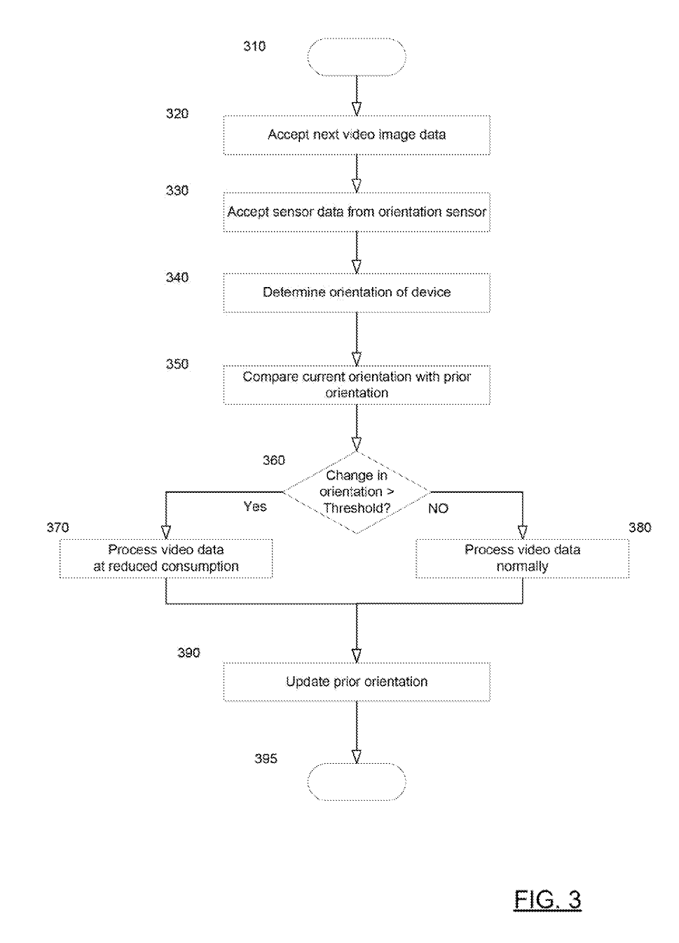

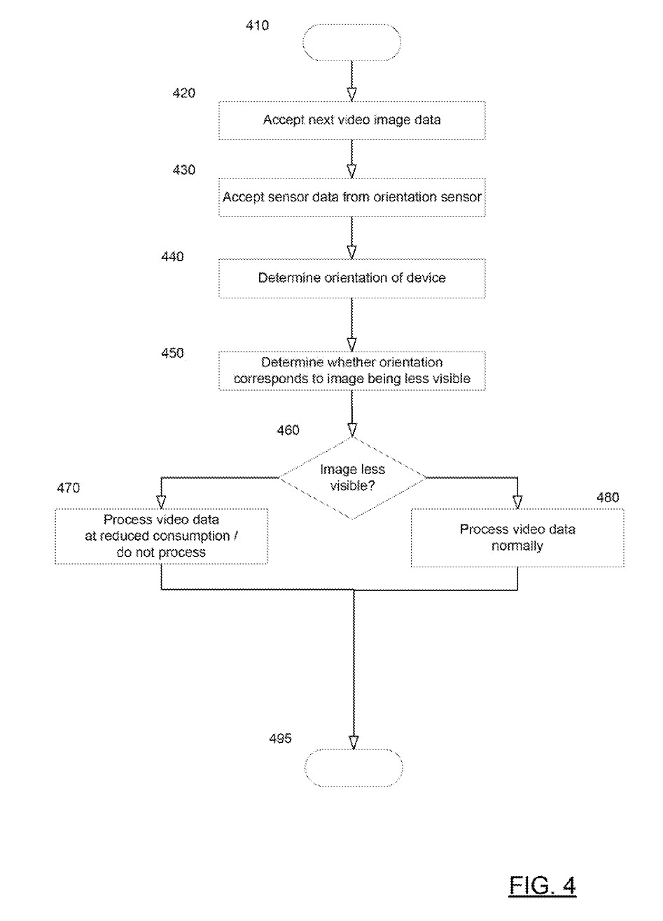

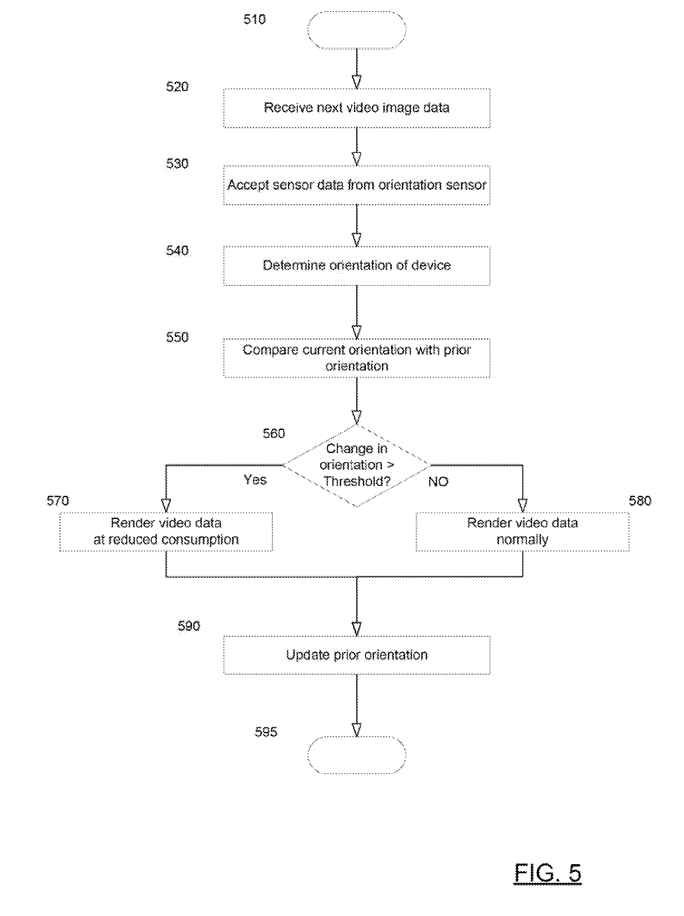

FIG. 3, FIG. 4, and FIG. 5 illustrate in flowcharts representative forms of preferred method embodiments.

FIG. 3 describes a form of a preferred embodiment in which the circumstance determined from data of an orientation sensor is that the mobile device is in motion, or its orientation is changing at a rate that makes details of a video image (either being accepted or being rendered) less perceivable. In some forms, the sensor is an accelerometer, and the direction of gravity (“down”) can be determined, and the orientation of the device with respect to “down”: orientation or changes in orientation with respect to other axes can also be determined, for example by integrating accelerometer measurements to determine a relative change in orientation. In other forms, the sensor is a gyroscopic sensor.

In the representative form of a preferred embodiment of FIG. 3. The steps of the process may be performed by a processor of a mobile device according to programming instructions stored in a memory of the device. The process starts at the step 310 as a next video image (or frame) is available from a camera of the device: the next video image is accepted from the camera performing the method at 320. At 330 the processor accepts sensor data from a sensor responsive to orientation (accelerometer, gyroscopic sensor, etc.). Next at 340 the processor determines the orientation of the device, such as with respect to the three axes defined by the plane of a touchscreen of the device (see discussion for FIG. 2). Subsequently, at 350, the processor fetches a stored value from a memory of the processor for a prior orientation of the device, and compares it with the current orientation determined in step 340.

At 360, the processor determines whether the orientation of the device has changed greater than a predetermined threshold. If not, the method continues to 380, where the video data is processed “normally”. If so, the method continues to 370, where the video data is processed in a fashion that uses a different amount of a resource: for example, the data may not be transmitted, or some video frames or images may be skipped, or data may be encoded at a lesser resolution. In the embodiments, the predetermined threshold may be determined at least in part dynamically, for example based on a history of how the device has been moved or oriented, before, or in based on an input from another sensor, or a based on a previous orientation for a period of time.

Subsequent to either of steps 370 or 380, the processor updates the stored values for the prior orientation of the device with data of the current orientation, and completes and may continue to other operations at 395.

In alternative forms of the embodiment, FIG. 4 describes a form of a preferred embodiment in which the circumstance determined is that the device is oriented such that the desired image is not visible, or would be less visible. In some forms, the sensor is a proximity sensor, in others it may be a touch sensor such as a touch surface of the mobile device, in others without limitation the sensor is an accelerometer, or may be a combination of sensors. The embodiment starts at 410 as a next video image (or frame) is available from a camera of the mobile device: the next video image is accepted from the camera as shown at 420. At 430 the processor accepts sensor data from a sensor. At 440 the processor of the device determines the orientation of the device, and at 450 determines whether the orientation corresponds to an orientation such that the image is less visible, or not visible to a user.

In some forms, the orientation is that the device is face-down, and presumed to be on a surface that blocks the camera or the user's view of the display. In some embodiments, the orientation is determined by an accelerometer, in others the orientation is determined both by an accelerometer and by proximity or contact data with the side of the device with the camera or the display. In others, an orientation in which the camera or display are blocked is determined by contact or proximity sensor data that indicates that the device may be being held up to the side of a user's head, as in a voice chat or telephone chat.

At 460, the processor determines whether the image is less visible than a threshold. If not, the image data is processed normally, as indicated at 480. If so, the image or video data is processed in a fashion that consumes less of a resource, as indicated at 470. Subsequent to either of steps 470 or 480, the method completes and processing may continue to further operations as shown at 495.

In some forms of a preferred embodiment, the processing at more optimal consumption of a resource as indicated at 470 may be that video information is processed or encoded at lower temporal resolution (e.g. not all frames are sent), or at a less image detail (e.g. lower image resolution, lower color resolution. Such techniques, and others, may be applied in the step as a matter of design choice. It will readily be apparent that the invention is not limited in this or similar steps to processing techniques that may or may not be generally known in the art today.

FIG. 5 shows one form of a preferred embodiment in which the mobile device is a rendering device for video data. Details readily apparent, or readily apparent from the discussion of other figures, is omitted for brevity.

The embodiment starts at 510: at step 520 the processor of the device receives data representing a next video image: in many forms the data is received via a network connection, or read from a data storage device. At 530 the processor accepts sensor data from a sensor that may be used to determine an orientation of the device. At 540 the processor of the device determines the orientation of the device from the sensor data of 530. At 550 the processor compares the current orientation as determined at 540 with a prior orientation of the device.

At 560, the processor determines whether the change in orientation (e.g. the motion) of the devices is greater than a threshold. If not, the video data is rendered to display an image normally, as indicated at 580. If so, the image or video data is processed in a fashion that consumes less of a resource, as indicated at 570. Subsequent to either of steps 570 or 580, the method continues as shown at 590 to update the information about prior orientation, and the method then completes and processing may continue to further operations at shown at 595.

As will be easily appreciated, the above exemplary embodiments apply both to a device which is originating data, such as a device accepting images from a camera of the device, and processing that information, such as for storage or transmission, and also to a device that is receiving data, such as video data originating from another device or from storage, and processing that information, such as for display or local storage.

It is readily apparent that here are many variations on the steps and the ordering of the steps of the exemplary embodiments above, and techniques of the invention may be applied to other kinds of information than video information, and to other kinds and combinations of sensors and sensor data. Further, the step of determining whether a change is orientation is greater than a threshold may be implemented in multiple forms, such as a by determining a derivative, an integral, or measure of change in orientation, and the threshold may be either a minimum or maximum threshold, or combination of multiple factors, such as psycho-perceptual criteria. Thresholds used are matter of design choice, and may be determined experimentally. There may be multiple thresholds, and multiple forms of processing data at different rates of consumption, and the thresholds may be adaptable (such as being adapted in response to the mobile device having been in motion for a period of time), or settable.

Steps may also be performed in multiple components, for example the steps of processing video data depending on a determination of change in orientation may be performed on a separate processor or server.

As is readily apparent, the representative embodiment forms of FIG. 3, FIG. 4, and FIG. 5 differ from an embodiment of merely transforming an image to compensate for motion of a video camera (a form of image stabilization) by detecting motion of the video camera and transforming the image to reduce the resulting apparent motion of the image. It will be further apparent that they differ from an embodiment of merely using information of a sensor of motion in determining how to encode for motion in encoding or decoding of video information to maintain a desired level of detail for an image. It will also be readily appreciated that they differ from embodiments of power management that merely disable power to components or subsystems, or place components or subsystems into a non-functional “sleep” mode, in response to a period of inactivity, in response to sensing that available battery or other power is low, or in response to a specific input.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method comprising:
in a mobile device comprising at least a display, a processor and a memory, reading data of a sensor of the device;
determining from the sensor data that the device is in an operating circumstance for processing the data in a fashion that consumes a different amount of a resource; and
processing the data in a fashion that consumes a different amount of the resource.

2. The method of claim 1 wherein the data that is read is multimedia data.

3. The method of claim 1 where in the operating circumstance is that the mobile device is in an orientation.

4. The method of claim 3 wherein the orientation is an orientation where the mobile device is a displaying the data and video information is not be seen readily by a user.

5. The method of claim 1 wherein the operating circumstance is that there is insufficient ambient light for a camera of the mobile device to produce usable images.

6. The method of claim 1 wherein a quantity, a form, or a type of data processed or encoded is determined based on the sensor reading.

7. The method of claim 1 where processing the data comprises computational or communications processing of media data.

8. The method of claim 1 wherein the resource is a limited resource.

9. The method of claim 8 wherein the limited resource is battery power

10. The method of claim 8 wherein the limited resource is bandwidth.

11. The method of claim 8 wherein the limited resource is processing for real time audio and/or video data.

12. A method comprising:
in a mobile device comprising at least a display, a processor and a memory, receiving video data;
receiving sensor data from an orientation sensor in the mobile device;
determining a current orientation of the mobile device from the received sensor data;
comparing the current orientation of the mobile device with a prior orientation of the mobile device;
if the current change in orientation exceeds a threshold orientation, processing the received video data at a reduced rate of consumption; and
if the current change in orientation does not exceed the threshold orientation, processing the received video data at a normal rate of consumption.
